(19) United States
(12) Patent Application Publication
(10) Pub. No.: US 2015/0360587 A1
(43) Pub. Date: Dec. 17, 2015

(54) SPINDLE GEAR UNIT FOR AN ADJUSTING MECHANISM IN A MOTOR VEHICLE AND VEHICLE SEAT

(71) Applicant: JOHNSON CONTROLS METALS AND MECHANISMS GMBH & CO. KG, Solingen (DE)

(72) Inventors: Andreas HOFFMANN, Wuelfrath (DE); David BALZAR, Leichlingen (DE)

(21) Appl. No.: 14/761,104

(22) PCT Filed: Jan. 29, 2014
(86) PCT No.: PCT/EP2014/051707

§ 371 Date: Jul. 15, 2015

(30) Foreign Application Priority Data
Jan. 30, 2013 (DE) 10 2013 001 804.8
Apr. 26, 2013 (DE) 10 2013 207 665.7

(51) Int. Cl. B60N 2/06; B60N 2/02

(52) U.S. Cl. CPC B60N 2/067; B60N 2/0232; B60N 2002/0236

(57) ABSTRACT

A spindle gear unit (10), for an adjusting mechanism in a motor vehicle seat, includes a housing (20, 22), a spindle nut (40, 140, 240) cooperating with a spindle (30). The spindle nut (40, 140, 240) has external toothing (44, 144, 244) and has at least one bearing surface (46, 146, 246) for rotatably mounting the spindle nut (40, 140, 240) in the housing (20, 22). A thrust washer (50, 150, 250) is put on and encompasses the bearing surface (46, 146, 246). A screw (70) is rotatably mounted in the housing (20, 22) and has a worm gear (72) which is in engagement with the external toothing (44, 144, 244). The thrust washer (50, 150, 250) is pressed onto the spindle nut (40, 140, 240). A vehicle seat is also provided with the spindle gear unit for driving a seat rail of a length adjuster of the vehicle seat.

### CROSS REFERENCE TO RELATED APPLICATIONS

This application is a United States National Phase Application of International Application PCT/EP2014/051707 filed Jan. 29, 2014 and claims the benefit of priority under 35 U.S.C. §119 of German Patent Applications 10 2013 001 804.8 filed Jan. 30, 2013 and 10 2013 207 665.7 filed Apr. 26, 2013, the entire contents of which are incorporated herein by reference.

### FIELD OF THE INVENTION

The invention relates to a spindle gear unit for an adjusting mechanism in a motor vehicle, in particular in a motor vehicle seat, comprising a housing, a spindle nut for cooperation with a spindle, wherein the spindle nut has an external toothing and the spindle nut has at least one bearing surface for rotatably mounting the spindle nut in the housing, a thrust washer which is positioned on the bearing surface and encompasses said bearing surface and a worm which is rotatably mounted in the housing and has a worm gear which is in engagement with the external toothing of the spindle nut.

The invention further relates to a vehicle seat.

### BACKGROUND OF THE INVENTION

A generic spindle gear unit is disclosed in DE 103 62 040 B4. A thrust washer absorbing axial forces, which, on the one hand, bears in the axial direction against a spindle nut and is connected fixedly in terms of rotation thereto and which, on the other hand, is supported in the axial direction on a bearing bush of a gear housing, comprises a projection which engages in a corresponding recess of the spindle nut and, as a result, forms a rotational locking. The rotational locking prevents noise being generated by relative movements between the thrust washer and the spindle nut. The threading of the projection of the thrust washer into the recess of the spindle nut requires a corresponding alignment of the thrust washer relative to the spindle nut and thus involves an additional operating step when mounting the spindle gear unit. Additionally, problems may arise in terms of quality control due to damage and the formation of chips on the spindle nut during the mounting of the gear unit by the projection of the thrust washer.

DE 10 2005 001 333 A1 discloses a spindle gear unit with thrust washers which sit on projections but are not pressed onto said projections.

A spindle gear unit comprising a spindle nut is disclosed in DE 10 2007 027 410 A1, said spindle nut comprising two bearing surfaces and an external toothing arranged between the bearing surfaces. One bearing surface of the spindle nut is mounted by means of five washers in a complex manner. For mounting the second bearing surface a thrust washer is provided. The washers and the thrust washer are located with clearance on the associated bearing surfaces and are not pressed onto said bearing surfaces.

### SUMMARY OF THE INVENTION

An object of the invention is based on improving a spindle gear unit for an adjusting mechanism of the type mentioned in the introduction, in particular providing a gear unit construction which is simple to mount, in which at least one thrust washer is connected fixedly in terms of rotation to a spindle nut, in particular without the thrust washer having to have a projection.

As the thrust washer is pressed onto the spindle nut, in particular onto a projection of the bearing surface of the spindle nut, during the mounting process the thrust washer may be supplied without positional orientation and alignment. The thrust washer may additionally be a simple, planar component and less complex than conventional thrust washers with a projection. By being pressed from outside, a smooth surface may additionally be ensured on the running surface of the thrust washer relative to the bearing bushes.

The term “pressed” is to be understood as an interference fit (press fit) in which before the joining process the largest dimension of the bore of the thrust washer is always smaller than the smallest dimension of the geometry of the spindle nut onto which the thrust washer is applied. “Shrink-fitted” which is known per se and which is based on the principle of thermal expansion is also intended to be understood hereinafter by the term “pressed”.

Particularly low production costs are achieved when the at least one bearing surface has a circular cylindrical external contour, the central axis thereof being aligned with a rotational axis of the spindle nut. Alternatively, however, bearing surfaces may also be provided which deviate from the circular shape as is disclosed, for example, in DE 103 27 654 A1.

The bearing surface may comprise, in addition to the external contour serving for mounting the spindle nut, further portions which are preferably arranged in the axial direction adjacent to the external contour, for example grooves or projections, i.e. diametral stepped portions.

If the spindle nut comprises just two bearing surfaces, the external toothing being arranged therebetween, two thrust washers may be pressed simultaneously in opposing directions. The resulting forces on the spindle nut are then mutually cancelled out.

Pushing the thrust washer onto the spindle nut may be achieved in a particularly simple manner by the thrust washer comprising an opening configured as a central hole with a diameter which is slightly larger than the external diameter of the external contour for the rotatable mounting of the spindle nut. The diameter of the opening is preferably slightly smaller than the external diameter of a projection of the bearing surface onto which the thrust washer is pressed. Preferably, the difference in diameter is 0.05 mm to 0.2 mm.

Pushing the thrust washer onto the external contour of the bearing surface is achieved in a particularly simple manner by the projection being configured in a transition region between the bearing surface and the external toothing. The thrust washer may be initially pushed easily onto the bearing disk until the thrust washer finally reaches the projection and is pushed onto said projection. A chamfer on the end of the bearing surface remote from the external toothing simplifies the pushing of the thrust washer onto the bearing surface, by the thrust washer being centered and threaded-on by the chamfer.

The projection preferably protrudes at least partially over the external contour of the bearing surface. However, the projection does not have to have a circular cross section but, for example, may also have a polygonal or toothed configuration.

By pressing the thrust washer onto the projection of the spindle nut, a non-positive connection is produced between the thrust washer and the spindle nut. An alternative or additional positive connection may be achieved in that the extent of the external toothing in at least one axial direction is defined in a radially internal region of the external toothing by a front face oriented in the radial direction, and at least one retaining tip of the external toothing in a radial outer region of the external toothing protrudes in the axial direction over the front face in the direction of the thrust washer and the at least one retaining tip engages positively in a recess of the thrust washer.

Preferably, a plurality of retaining tips are provided, said retaining tips being uniformly distributed over the periphery of the spindle nut, in particular each tooth of the external toothing forms a retaining tip in each of the two axial directions. The two thrust washers accordingly have correlating recesses which are formed, in particular, by pressing the thrust washer onto the spindle nut. The formation of the recesses may be achieved particularly effectively by the strength of the material of the spindle nut being greater than the strength of the material of the thrust washer.

A recess in the form of a groove in the transition region between the bearing surface and the external toothing of the spindle nut may receive chip material which may form when the thrust washer is pressed on. The groove is preferably configured in each case adjacent to one of the two front faces of the spindle nut, in particular between one of the projections and the associated front face.

A vehicle seat which is provided with a spindle gear unit according to the invention, in particular for driving a seat rail of a longitudinal seat adjuster and/or for driving a height adjuster, has cost advantages and as a result greater commercial value relative to a conventional vehicle seat.

In a particularly cost-effective manner the thrust washers may be designed as planar stamped parts. The thrust washers in this case are preferably designed with a uniform material thickness and to be rotationally symmetrical, with a circular external diameter and a hole positioned centrally thereto. The internal diameter of this hole is designed as a simple press fit for the projection of the bearing surface.

The invention is described in more detail hereinafter with reference to a figure for the prior art and two advantageous exemplary embodiments shown in the remaining figures. The invention, however, is not limited to these exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded view of a spindle gear unit known from the prior art;

FIG. 2 is a perspective view of a spindle nut of a first exemplary embodiment of a spindle drive according to the invention;

FIG. 3 is a view of the spindle nut corresponding to FIG. 2 comprising a thrust washer partially pushed on during mounting;

FIG. 4 is a view corresponding to FIG. 3 with the thrust washer fully pressed on;

FIG. 5 is a side view of a part of the spindle nut of the first exemplary embodiment;

FIG. 6 is a section through the detail VI of FIG. 5;

FIG. 7 is a perspective view of a spindle nut of a second exemplary embodiment;

FIG. 8 is a side view of a part of the spindle nut of the second exemplary embodiment; and

FIG. 9 is a section through the detail IX of FIG. 8.

### DESCRIPTION OF THE PREFERRED EMBODIMENTS

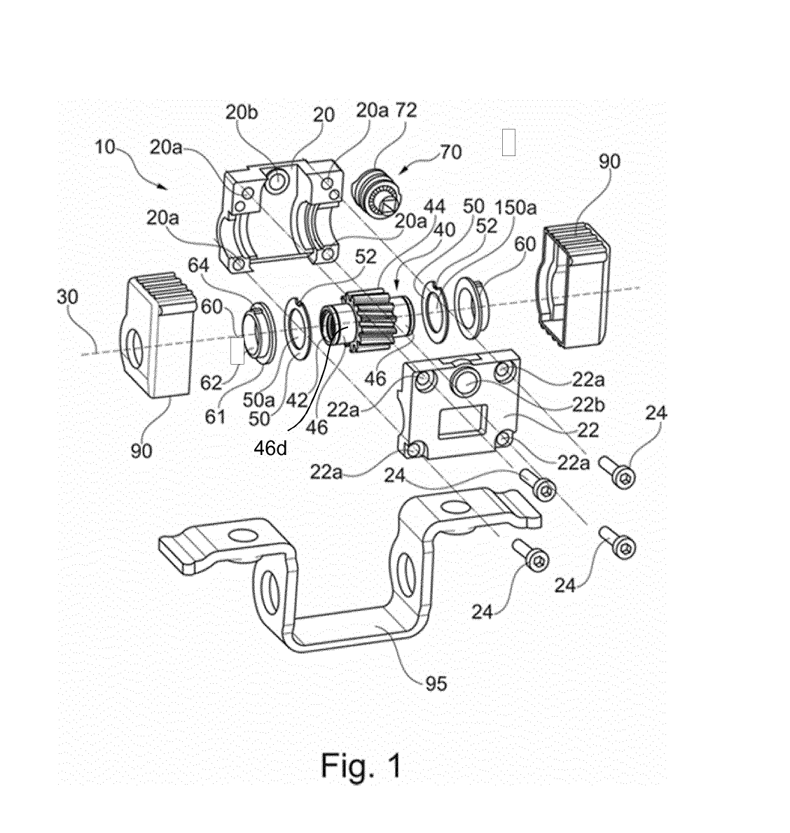

FIG. 1 shows a spindle gear unit 10 that is known from the prior art.

The spindle gear unit 10 comprises a housing which is made up of a first housing part 20 and a second housing part 22. The two housing parts 20, 22 in the present case are connected together by four screws 24 provided in each case with a self-tapping external thread. Each of the four screws 24 passes through one respective through-hole 22a in the second housing part 22 and is screwed with its self-tapping external thread in one respective circular cylindrical hole 20a of the first housing part 20.

The housing 20, 22 forms an internal space and bearing regions for, on the one hand, a spindle nut 40 and, on the other hand, a worm 70 which together form a worm gear stage. The rotational axis of the spindle nut 40 defines an axial direction which is frequently oriented approximately in the direction of travel in spindle gear units for longitudinal seat adjusters in vehicles. The housing 20, 22 is continuously open in the axial direction for receiving a spindle 30 which in FIG. 1 is shown only schematically by a dashed line. The spindle 30 has along its axial extent an external thread for cooperating with the spindle nut 40. To this end, the spindle nut 40 has an internal thread 42 which is in engagement with the external thread of the spindle 30. An external toothing 44 of the spindle nut cooperates with a worm gear 72 of the worm 70.

Viewed in the axial direction, the spindle nut 40 has on both sides of the external toothing 44 in each case a bearing surface 46 which substantially comprises a cylindrical external contour 46d which has an external diameter which is smaller than the external diameter of the external toothing 44 at the lowest points of the teeth, i.e. smaller than the internal circle of this external toothing 44. A planar thrust washer 50 with a circular opening 50a is positioned on each of the two outer bearing surfaces 46, said thrust washer comprising two main surfaces spaced apart from one another by a material thickness of the thrust washer, in each case facing outwardly and oriented perpendicular to the axial direction. The two main surfaces are preferably fully coated with a lubricating lacquer, in particular with PTFE.

The thrust washer 50 has a projection 52 which protrudes axially but also could be configured radially. The axial projection 52 engages in the mounted state between two teeth of the external toothing 44, whereby a rotational locking of the thrust washer is achieved relative to the external toothing 44. This rotational locking may have a small degree of clearance which may be adjusted, for example, by adapting the dimensions of the projection 52. In principle, however, the thrust washer 50 is coupled to the rotational movement of the spindle nut 40 due to the projection 52.

A bearing bush 60 is located on the two outer bearing surfaces 46, in each case in the vicinity of the main surface of each thrust washer 50 remote from the external toothing 44, said bearing bush comprising a ring 61 which by its basic geometry substantially corresponds to the thrust washer 50 and which has a circular cylindrical collar 62 of smaller external diameter, facing away from the external toothing 44. The internal diameter of the collar 62 approximately corresponds to the external diameter of the associated bearing surface 46. A lug 64 protrudes in the radial direction from the collar 62 of the bearing bush 60. The bearing bush 60 is preferably made of a metallic bearing material.

In the first housing part 20 and the second housing part 22 in each case semi-circular bearing grooves are provided for receiving the bearing bushes 60. The housing 20, 22 also has a recess which receives the lug 64 so that the bearing bush 60 is not able to not rotate relative to the housing 20, 22.

During the operation of the spindle gear unit 10, a relative rotation takes place between the bearing bush 60 connected fixedly in terms of rotation to the housing 20, 22 and the thrust washer 50 which is connected fixedly in terms of rotation to the spindle nut 40 rotating relative to the housing 20, 22. Due to the axial forces, frictional forces occur in this case between the bearing bush 60 and the thrust washer 50 which may be kept as low as possible by a suitable material pairing.

Moreover, the worm 70 is rotatably mounted in the housing 20, 22. The axis of the worm 70 extends substantially at right angles and is offset to the axis of the spindle nut 40 and the spindle 30. The worm 70 has a worm gear 72 on its outer circumference and on the inside a polygonal receiver for receiving a driving shaft, in particular a resilient shaft. The worm 70 is preferably rotatably mounted by a ball bearing on each of its axial ends respectively in one specific bearing opening 20b, 22b in the housing 20, 22. A first bearing opening 20b is incorporated in this case in the first housing part 20 and a second bearing opening 22b is incorporated in the second housing part 22. Additionally, bearing bushes, not shown in FIG. 1—similar to the bearing bushes 60—may be provided for mounting the worm gear in the housing 20, 22.

In a manner known per se, the gear unit is encompassed by two shells 90 made of rubber or a corresponding material suitable for noise damping and is accommodated in a substantially U-shaped angle bracket 95 which is fastened, for example, to or in a rail profile of a longitudinal seat adjuster for a vehicle.

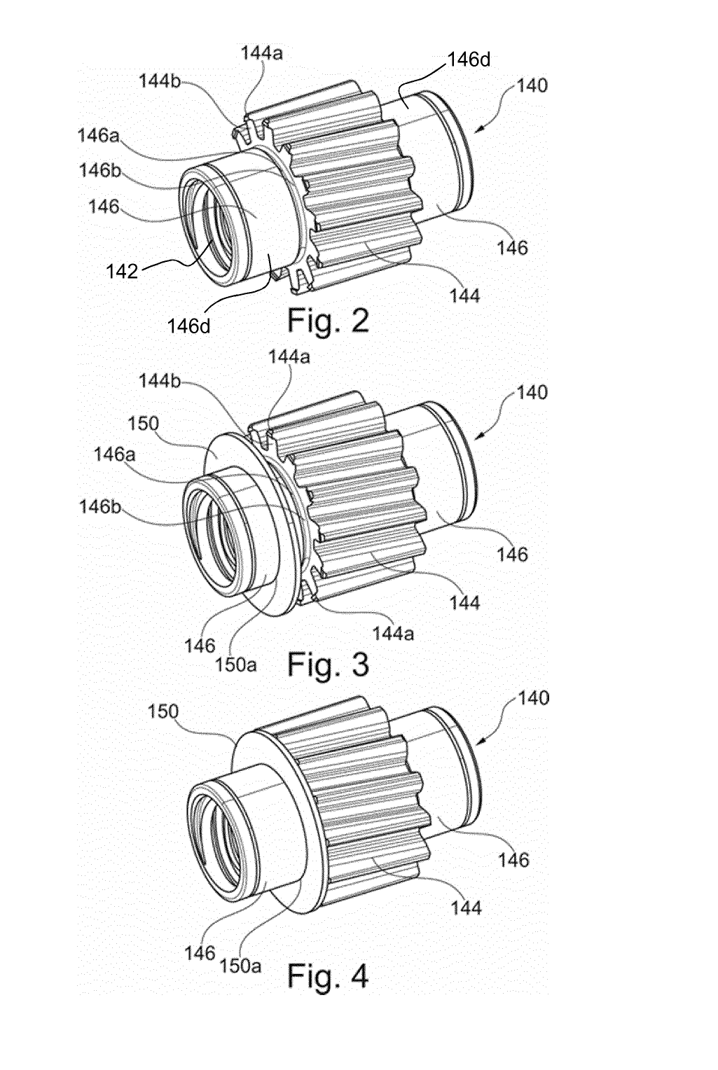

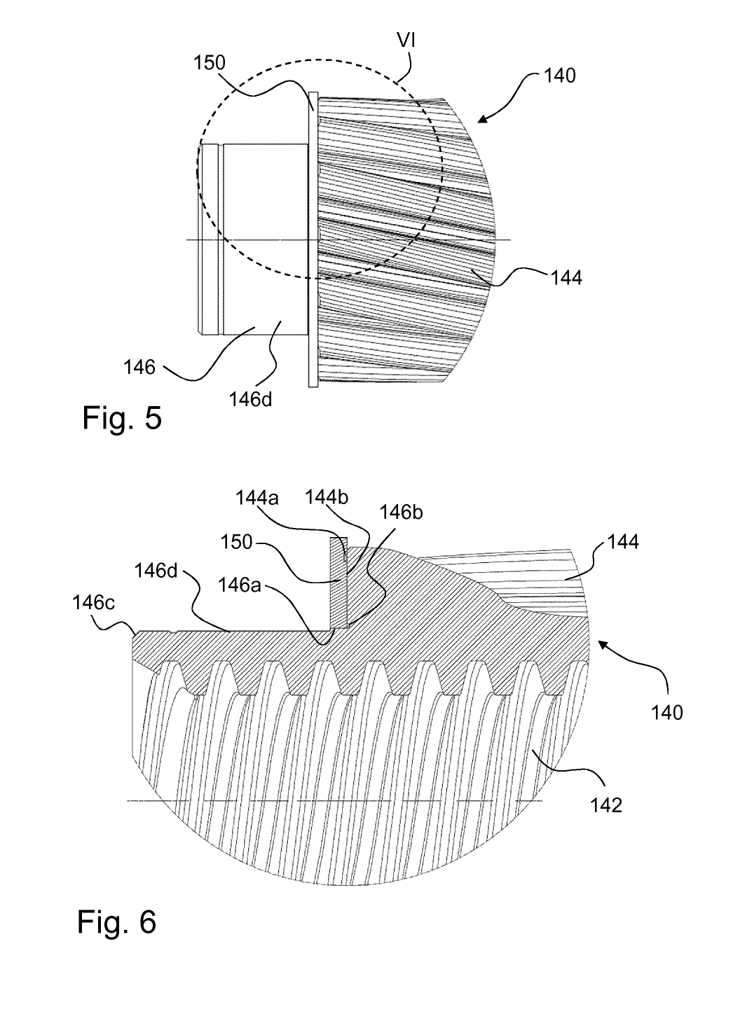

A spindle nut 140 of a first exemplary embodiment of a spindle gear unit according to the invention is shown in FIGS. 2 to 6, the construction thereof—provided not described differently hereinafter—corresponding to the spindle gear unit 10 of the prior art described above. The components which are different from the prior art have reference numerals increased by 100.

The spindle nut 140 which in basic construction and mode of operation substantially corresponds to a spindle nut 40 of the prior art, has an external toothing 144 for cooperating with the worm gear 72 of the worm 70. In the axial direction, the spatial extent of the external toothing 144 in both directions in a radial inner region, the diameter thereof being slightly smaller than the tip circle diameter of the external toothing 144, is defined by one respective substantially planar front face 144b. In the radial outer region of the external toothing 144, said external toothing respectively protrudes slightly over the associated front face 144b to the side in the axial direction. As a result, each tooth of the external toothing 144 on both sides has one respective retaining tip 144a protruding over the associated front face 144b, which preferably has an axial extent of a few tenths of a millimeter.

Viewed in the axial direction on both sides of the external toothing 144, the spindle nut 140 in each case has a bearing surface 146 which comprises an external contour 146d for the rotatable mounting of the spindle nut 140, the basic geometry thereof being circular cylindrical, and which has an external diameter which is smaller than the external diameter of the external toothing 144 at the lowest points of the teeth, i.e. smaller than the internal circle of this external toothing 144.

In the transition regions to the front faces 144b, i.e. between the external contour 146d and the front face 144b, the bearing surfaces 146 in each case comprise a peripheral projection 146a. In the region of the projection 146a the diameter of the bearing surfaces 146 is slightly larger than in the region of the external contours 146d.

The diameter of the projection 146a is preferably 0.05 mm to 0.2 mm larger than the diameter of the external contour 146d.

A peripheral groove 146b between the front face 144b and the projection 146a serves for receiving chips, which are produced in the process of pressing the thrust washer 150 onto the projection 146a described hereinafter.

A planar, circular thrust washer 150 with a circular opening 150a is positioned on each of the two outer bearing surfaces 146, said thrust washer comprising two main surfaces spaced apart from one another by the material thickness of the thrust washer 150, in each case facing outwardly and oriented perpendicular to the axial direction. The central point of the circular opening 150a is identical to the central point of the circular thrust washer 150. The diameter of the opening 150a corresponds to the diameter of the external contour 146d of the bearing surface 146 or is slightly larger. The diameter of the opening 150a, however, at least before mounting, is smaller than the diameter of the projection 146a, preferably by 0.05 mm to 0.02 mm. As a result, when mounting the spindle gear unit 10 the thrust washer 150 may be pushed over the external contour 146d of the bearing surface 146 without damaging said surface. Subsequently during the mounting process, however, the thrust washer 150 may simply press against the external contour 146d.

The thrust washer 150 differs from a thrust washer 50 of the prior art described above, therefore, in the design of the rotational locking to the spindle nut 140. The thrust washer 150 is coupled to the rotational movement of the spindle nut 140, by the opening 150a of the thrust washer 150 being located on the projection 146a with a press fit, due to the described difference in diameter.

One end of each bearing surface 146 remote from the external toothing 144 has a chamfer 146c which is configured so that, during the mounting of the spindle gear unit, the pushing of the thrust washer 150 onto the bearing surface 146 is simplified.

The thrust washer 150 is designed as a planar stamped part. The strength and/or hardness of the thrust washer is reduced relative to the strength and/or hardness of the projection 146a and the external toothing 144. After supplying the two thrust washers 150 onto both bearing surfaces 146, the two thrust washers 150 are pushed axially toward one another in the direction of the respectively associated front face 144b, and subsequently pressed onto the projections 146a. The softer material of the thrust washers 150 in this case is pushed onto the harder projection 146a. The retaining tips 144a of the external toothing in the present case penetrate the thrust washer 150, preferably sufficiently far until a main surface of the thrust washer 150 bears flat against the front face 144b of the external toothing 144. By the penetration of the retaining tips 144a into the thrust washer 150 a positive driving is ensured by the spindle nut 140.

Pressing the thrust washer 150 onto the projection 146a may result in the formation of chips. The resulting chips are received in the groove 146b.

Naturally, the supply of the thrust washer 150 may take place separately during the mounting process, without positional orientation being necessary.

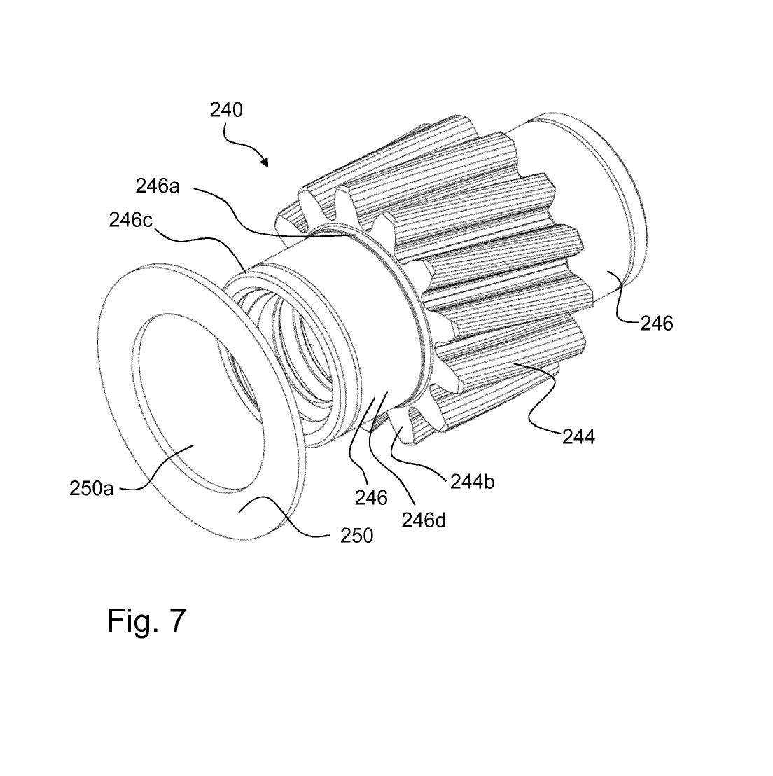

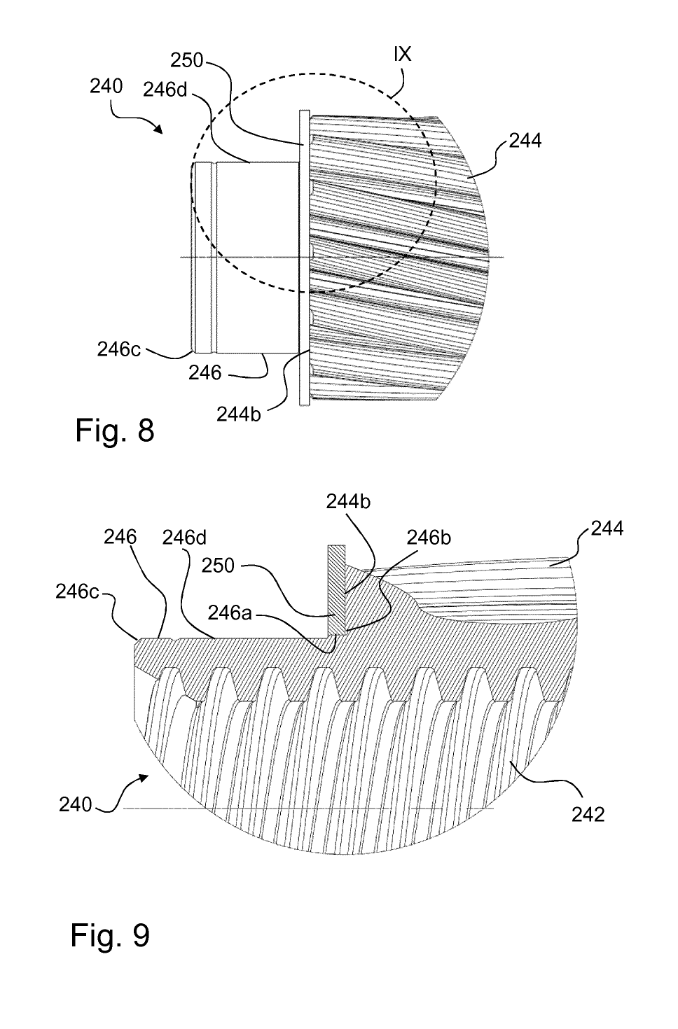

A spindle nut 240 of a second exemplary embodiment of a spindle gear unit according to the invention is shown in FIGS. 7 to 9, the construction thereof—provided not described differently below—corresponding to the spindle gear unit 10 of the prior art described above. The components which are different from the prior art have reference numerals increased by 200.

A connection which is fixed in terms of rotation between the spindle nut 240 and a thrust washer 250 takes place exclusively in a non-positive manner via a press fit between a projection 246a and the thrust washer 250. The thrust washer 250 bears flat against a front face 244b of the spindle nut 240, in the present case against a front face 244b of an external toothing 244. In contrast to the first exemplary embodiment, geometric shapes which act in the same manner as the retaining tips 144a are not provided on the spindle nut 240.

The remaining features and mounting steps of the second exemplary embodiment correspond to the first exemplary embodiment. The components of the second exemplary embodiment, therefore, bear reference numerals which are increased by 100 relative to the first exemplary embodiment. The differences between the first exemplary embodiment and the second exemplary embodiment, therefore, are limited to the presence or absence of retaining tips.

In particular, an internal thread 242, two bearing surfaces 246, a groove 246b, a chamfer 246c, an external contour 246d and in each case an opening 250a in the two thrust washers 250 correspond to the described components of the first exemplary embodiment.

In a modification of the second exemplary embodiment, retaining tips are provided but they do not penetrate into the thrust washers 250. The connection which is fixed in terms of rotation between the spindle nut 240 and the thrust washer 250 takes place exclusively in a non-positive manner via the press fit between the projection 246a and the thrust washer 250.

The features disclosed in the above description, the claims and the drawings may be significant both individually and also in combination for implementing the invention in its various embodiments.

While specific embodiments of the invention have been shown and described in detail to illustrate the application of the principles of the invention, it will be understood that the invention may be embodied otherwise without departing from such principles.

1. A spindle gear unit for an adjusting mechanism in a motor vehicle seat, the spindle gear unit comprising:
a housing;
a spindle nut for cooperation with a spindle, wherein the spindle nut has an external toothing and the spindle nut has at least one bearing surface for rotatably mounting the spindle nut in the housing;
a thrust washer which is positioned on the bearing surface and encompasses said bearing surface; and
a worm which is rotatably mounted in the housing and has a worm gear which is in engagement with the external toothing of the spindle nut, wherein the thrust washer is pressed onto the spindle nut.

2. The spindle gear unit as claimed in claim 1, wherein the at least one bearing surface has a circular cylindrical external contour for the rotatable mounting of the spindle nut in the housing the central axis thereof being aligned with a rotational axis of the spindle nut.

3. The spindle gear unit as claimed in claim 2, wherein the at least one bearing surface comprises a projection for mounting the thrust washer fixedly in terms of rotation, the thrust washer being pressed onto said projection.

4. The spindle gear unit as claimed in claim 3, wherein the projection, in the radial direction, protrudes at least partially over the external contour for rotatably mounting the spindle nut.

5. The spindle gear unit as claimed in claim 4, wherein the projection has a circular cross section and the diameter of the projection is 0.05 mm to 0.2 mm larger than the diameter of the external contour for rotatably mounting the spindle nut.

6. The spindle gear unit as claimed in claim 1, wherein the spindle nut comprises two specific bearing surfaces the external toothing being arranged therebetween.

7. The spindle gear unit as claimed in claim 3, wherein the at least one bearing surface comprises a projection in a transition region between the bearing surface and the external toothing.

8. The spindle gear unit as claimed in claim 1, wherein the axial extent of the external toothing is defined in at least one axial direction by a front face oriented in the radial direction.

9. The spindle gear unit as claimed in claim 8, wherein the thrust washer bears against the front face.

10. The spindle gear unit as claimed in claim 8, wherein at least one retaining tip protrudes in the axial direction over the front face in the direction of the thrust washer.

11. The spindle gear unit as claimed in claim 10, wherein the at least one retaining tip is arranged in a radial outer region of the external toothing.

12. The spindle gear unit as claimed in claim 10, wherein the at least one retaining tip engages positively in a recess of the thrust washer and the recess of the thrust washer is formed by pressing the thrust washer onto the spindle nut.

13. The spindle gear unit as claimed in claim 1, wherein a strength of the material of the spindle nut is greater than the strength of the material of the thrust washer.

14. The spindle gear unit as claimed in claim 8, wherein the spindle nut adjacent to the front face, between the projection a and the front face has a peripheral groove for receiving chips which are produced when the thrust washer is pressed onto the spindle nut.

15. A vehicle seat comprising a spindle gear unit, the spindle gear unit comprising:
a housing;
a spindle nut for cooperation with a spindle, wherein the spindle nut has external toothing and the spindle nut has at least one bearing surface for rotatably mounting the spindle nut in the housing;
a thrust washer which is positioned on the bearing surface and encompasses said bearing surface; and
a worm which is rotatably mounted in the housing and has a worm gear which is in engagement with the external toothing of the spindle nut, wherein the thrust washer is pressed onto the spindle nut, wherein the spindle gear unit is for driving a seat rail of a longitudinal seat adjuster of the vehicle seat.
